(19) United States
(12) Patent Application Publication
(10) Pub. No.: US 2011/0001738 A1
(43) Pub. Date: Jan. 6, 2011

(54) DISPLAY DEVICE AND DRIVING METHOD THEREOF

(75) Inventors: Sung-Jin HONG, Seoul (KR); Jae-Byung PARK, Seongnam-si (KR); Sung-Jin KIM, Seongnam-si (KR); Don-Chan CHO, Seongnam-si (KR); Hyun-Min CHO, Seoul (KR)

Correspondence Address: CANTOR COLBURN LLP, 20 Church Street, 22nd Floor, Hartford, CT, 06103, US

(73) Assignee: SAMSUNG ELECTRONICS CO., LTD., Suwon-si (KR)

(21) Appl. No.: 12/647,132

(22) Filed: Dec. 24, 2009

(30) Foreign Application Priority Data
Jul. 2, 2009 (KR) 10-2009-0060389

(51) Int. Cl. G09G 5/00

(52) U.S. Cl. 345/208

(57) ABSTRACT

A display device includes a gate line, a data line, a switching transistor connected to the data line, a variable resistance unit, a first capacitor connected to the variable resistance unit and a micro-shutter connected to the resistance unit and the first capacitor. The switching transistor is controlled by a gate-on voltage supplied by the gate line, and a resistance of the variable resistance unit is changed based on a data voltage supplied to the variable resistance unit from the data line via the switching transistor. The micro-shutter electrode executes a shutoff operation based on a voltage at a connection node between the variable resistance unit and the first capacitor.

This application claims priority to Korean Patent Application No. 10-2009-0060389, filed on Jul. 2, 2009, and all the benefits accruing therefrom under 35 U.S.C. §119, the content of which in its entirety is herein incorporated by reference.

### BACKGROUND OF THE INVENTION

(a) Field of the Invention

The present invention relates to a display device and a driving method thereof. More particularly, the present invention relates to a display device including microshutter electrodes and a driving method thereof.

(b) Description of the Related Art

Generally speaking, display devices have developed from older, non-flat panel displays, such as cathode ray tube (“CRT”) displays, to relatively newer flat panel displays, such as liquid crystal displays (“LCDs”) and plasma display panels (“PDPs”), for example. The CRT displays display an image by causing an electron beam emitted from a rear portion of the display to collide with a fluorescent material on a front portion thereof. Thus, the CRT display has a significant disadvantage in that, as a size of the display increases, a depth thereof substantially increases, effectively limiting an increase in the size of the display device.

Due to this disadvantage (among others) of the CRT display, flat panel displays are being developed, such as the LCDs and PDPs noted above. These flat panel displays provide advantages in that, even when a size of the display is increased, a width thereof is not required to be increased. Accordingly, larger flat panel displays can be manufactured, as compared to sizes of the CRT displays.

However, even the flat panel displays have some disadvantages. For example, the LCDs have a slow response speed and the PDPs have high power consumption, as compared to other types of displays.

Accordingly, there is a need to develop display devices that overcome the above-mentioned deficiencies and disadvantages.

### BRIEF SUMMARY OF THE INVENTION

The present invention provides a display device including micro-shutter electrodes, and a method of driving the display device.

A display device according to an exemplary embodiment of the present invention includes: a gate line; a data line; a switching transistor connected to the gate line and the data line and controlled by a gate-on voltage applied to the gate line; a variable resistance unit, a resistance of which is changed based on a data voltage supplied to the variable resistance unit from the data line via the switching transistor; a first capacitor connected to the variable resistance unit; and a micro-shutter electrode connected to the variable resistance unit and the first capacitor. The micro-shutter electrode executes a shutoff operation based on a voltage at a connection node between the variable resistance unit and the first capacitor.

The voltage at the connection node is discharged at a rate determined by a multiple of the resistance of the variable resistance unit and a capacitance of the first capacitor.

The variable resistance unit includes a variable resistance transistor, and the resistance of the variable resistance unit is a resistance between an input terminal and an output terminal of the variable resistance transistor. The resistance between the input terminal and the output terminal is changed based on the data voltage inputted to a control terminal of the variable resistance transistor.

A first terminal of the first capacitor is connected to the micro-shutter electrode, a second terminal of the first capacitor is connected to ground, the input terminal of the variable resistance transistor is connected to the first terminal of the first capacitor, and the output terminal of the variable resistance transistor is connected to ground.

The display device may further include a first initialization unit which initializes the voltage at the connection node.

The display the first initialization unit includes a first initialization transistor which is connected as a diode and which initializes the connection node with a first initialization signal.

The display device may further include a second initialization unit which initializes the control terminal of the variable resistance transistor.

The second initialization unit includes a second initialization transistor, a second initialization signal is inputted to the control terminal of the variable resistance transistor, an input terminal of the second initialization transistor is connected to the control terminal of the variable resistance transistor, and an output terminal second initialization transistor is connected to ground.

The display device may further include a second capacitor having a first terminal connected to the control terminal of the variable resistance transistor and a second terminal connected to ground.

The display device may further include a data voltage sustainer disposed between the control terminal of the variable resistance transistor and an output terminal of the switching transistor.

The data voltage sustainer may include: a third capacitor which stores the data voltage transmitted via the switching transistor; and an update transistor which transmits the data voltage stored in the third capacitor to the control terminal of the variable resistance transistor in response to an update signal.

The display device of may further include a backlight having a light source which emits light.

The light may lights having at least three colors, and the backlight may sequentially emit the lights having the at least three colors.

The backlight may emit white light.

The display device may further include a color filter which colors the white light emitted from the backlight, and the color filter includes at least three colors.

The micro-shutter electrode may include an opening.

In an exemplary embodiment, in a driving method of a display device for driving a pixel including a gate line, a data line, a switching transistor connected to the gate line and the data line, a micro-shutter electrode, a first capacitor connected to the micro-shutter electrode, a variable resistance transistor connected to the micro-shutter electrode and the first capacitor, and a data voltage sustainer disposed between the switching transistor and the control terminal of the variable resistance transistor, the method includes: initializing the variable resistance transistor; transmitting a data voltage stored in the data voltage sustainer to a control terminal of the variable resistance transistor; applying a gate-on voltage to the gate line to transmit the data voltage applied to the data line to the data voltage sustainer; and executing a shutoff operation of the micro-shutter electrode based on a rate of voltage discharge determined by a resistance of the variable resistance transistor and a capacitance of the first capacitor.

The transmitting the data voltage to the data voltage sustainer and the executing the shutoff operation of the micro-shutter electrode are may be performed simultaneously.

The display device may further include a plurality of pixels, and the transmitting the data voltage stored in the data voltage sustainer to the control terminal of the variable resistance transistor is simultaneously performed for all pixels of the plurality of pixels of the display device.

Accordingly, in a display device according to an exemplary embodiment of the present invention, a period that a micro-shutter electrode is turned on or off during one frame is controlled by using a resistor having a resistance that changes according to an input data voltage, such that a desired image is displayed.

### BRIEF DESCRIPTION OF THE DRAWINGS

The above and other aspects, advantages and features of the present invention will become more apparent by describing in further detail exemplary embodiments thereof with reference to the accompanying drawings, in which:

FIG. 1 is a partial schematic circuit diagram of an exemplary embodiment of a display device according to the present invention;

FIG. 2 is a graph of voltage versus time showing a driving voltage applied to a pixel of the display device shown in FIG. 1;

FIG. 3 is an equivalent schematic circuit diagram of the pixel of the display device shown in FIG. 1;

FIG. 4 is an equivalent schematic circuit diagram of a variable resistance transistor of the pixel shown in FIG. 3;

FIG. 5 is a graph of resistance versus voltage showing a change of resistance according to an application voltage of the variable resistance transistor shown in FIG. 4;

FIG. 6 is a graph of voltage versus time showing a voltage of an exemplary embodiment of a micro-shutter electrode of the pixel shown in FIG. 4;

FIG. 7 is an equivalent schematic circuit diagram of the pixel of the display device shown in FIG. 1;

FIG. 8 is a graph of voltage versus time showing an applied voltage and a voltage of a micro-shutter electrode of a pixel of the display device shown FIG. 1;

FIG. 9 is a graph of voltage versus time showing an on period of a micro-shutter electrode in the graph shown in FIG. 8;

FIG. 10 is a plan view showing a subdivided frame representing an image displayed on the display device of FIG. 1;

FIG. 11 is a schematic circuit diagram of an exemplary embodiment of a display device according to the present invention;

FIGS. 12-14 are graphs of voltage versus time showing voltages of the display device of FIG. 11;

FIG. 15 is a plan view showing a subdivided frame representing an image displayed on the display device of FIG. 11;

FIG. 16 is a partial cross-sectional view of the display device of FIG. 11;

FIG. 17 is a plan view showing an exemplary embodiment of a structure and an operation of a micro-shutter electrode according to the present invention;

FIG. 18 is a partial cross-sectional view of an exemplary embodiment of a micro-shutter electrode according to the present invention;

FIG. 19 is a plan view of a pixel in an exemplary embodiment of a display device according to the present invention; and

FIG. 20 is a plan view showing a subdivided frame representing an image displayed on the display device of FIG. 19.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the present invention will be described in further detail with reference to the accompanying drawings.

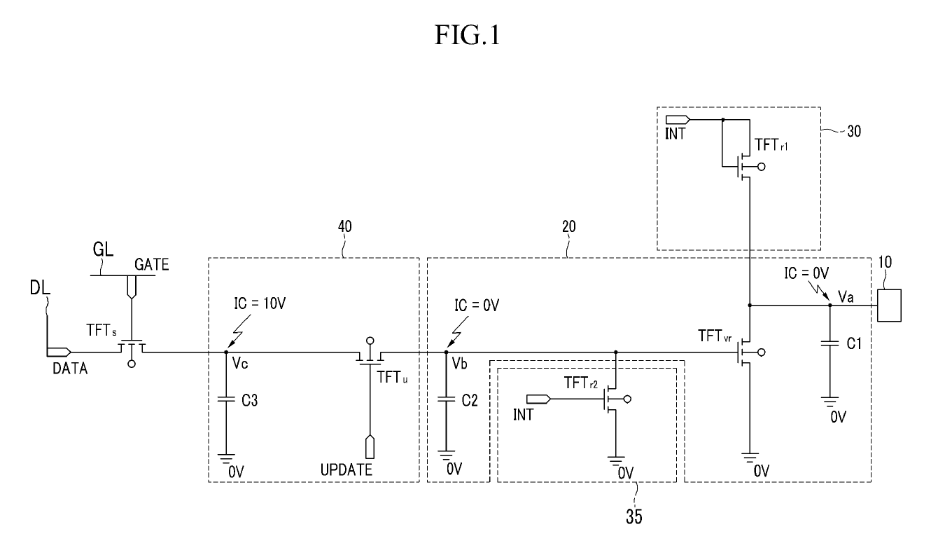

A structure of an exemplary embodiment of pixel of a display device according to the present invention will now be described in further detail with reference to FIG. 1, which is a partial schematic circuit diagram of an exemplary embodiment of a display device according to the present invention.

A display device according to an exemplary embodiment includes pixels that are arranged in a matrix pattern. FIG. 1 shows one pixel of the pixels that are arranged in the matrix pattern.

Referring to FIG. 1, the pixel of the display device according to an exemplary embodiment of the present invention includes a switching transistor TFTs connected to a gate line GL and a data line DL, a micro-shutter electrode 10 which executes a shutoff operation based on a threshold voltage, a variable resistor unit 20, a first initialization unit 30, a second initialization unit 35 and a data voltage sustainer 40. The variable resistor unit 20, the first initialization unit 30, the second initialization unit 35 and the data voltage sustainer 40 are disposed between the switching transistor TFT_{S} and the micro-shutter electrode 10, as shown in FIG. 1.

In an exemplary embodiment, the variable resistor unit 20 includes a variable resistance transistor TFTᵥᵣ. An input terminal of the variable resistance transistor TFTᵥᵣ is connected to a first capacitor C1, the micro-shutter electrode 10 and the first initialization unit 30 through a node Va, e.g., a connection node Va, and a control terminal of the variable resistance transistor TFTᵥᵣ is connected to a second capacitor C2, the second initialization unit 35 and the data voltage sustainer 40 through a node Vb. In addition, an output terminal of the variable resistance transistor TFTᵥᵣ is connected to a ground terminal, as shown in FIG. 1. In an exemplary embodiment, the second capacitor C2 included in the variable resistor unit 20 maintains a data voltage applied to the node Vb.

In the variable resistance transistor TFTᵥᵣ a value of current flowing between the input terminal and the output terminal thereof is determined based on a voltage applied through the control terminal thereof. More specifically, the value of the current flowing between the input terminal and the output terminal of the variable resistance transistor TFTᵥᵣ changes based on a voltage applied to the node Vb (e.g., a voltage of the second capacitor C2) such that a speed at which a voltage of the node Va, charged to the first capacitor C1, is discharged changes. In an exemplary embodiment, a resistance of the variable resistance transistor TFTᵥᵣ varies according to the voltage of the control terminal, and the variable resistance transistor TFTᵥᵣ is thereby operated as a variable resistor connected between the input terminal and the output terminal, such that the discharging speed of the node Va is determined according to a time constant value that is a multiple of the resistance between the input and output terminals of the variable resistance transistor TFTᵥᵣ and a capacitance of the first capacitor C1.

In an exemplary embodiment described herein, the variable resistance transistor TFTᵥᵣ is an element that functions as a variable resistor (the resistance of which is changed according to the voltage of the control terminal thereof), but alternative exemplary embodiments are not limited thereto. Instead, alternative exemplary embodiments of the present invention may include variable elements having characteristics that the resistance thereof is changed according to the input voltage instead of, or in addition to, the variable resistance transistor TFTᵥᵣ.

The micro-shutter electrode 10, which is connected to the node Va, executes the shutoff operation based on the voltage of the node Va. Specifically, the micro-shutter electrode 10 may be opened or closed when the voltage of the node Va is above a threshold voltage. More specifically, in an exemplary embodiment, when the voltage of the node Va is greater than the threshold voltage, the micro-shutter electrode 10 is opened, but alternative exemplary embodiments are not limited thereto. Thus, in an alternative exemplary embodiment, the micro-shutter electrode 10 may be opened when the voltage of the node Va is less than the threshold voltage. When the micro-shutter electrode 10 is opened, light that is incident to the micro-shutter electrode 10 transmits through the micro-shutter electrode 10, thereby displaying white, while the light is blocked by the micro-shutter electrode 10 when the micro-shutter electrode 10 is closed, thereby displaying black. The micro-shutter electrode 10 according to an exemplary embodiment may be formed with various structures, as will be described in further detail below.

Referring still to FIG. 1, the first initialization unit 30 initializes the voltage of the node Va connected to the side of the input terminal of the variable resistance transistor TFTᵥᵣ, and includes a first initialization transistor TFTᵣ₁ that is connected as a diode. The first initialization transistor TFTᵣ₁ is connected between the node Va and an input terminal of an initialization signal INT, the input terminal and the control terminal of the first initialization transistor TFTᵣ₁ are connected to the input terminal of the initialization signal NT, and the output terminal thereof is connected to the node Va, as shown in FIG. 1. When the first initialization unit 30 initializes the node Va, the voltage of the node Va has a value of a voltage conforming to the value of a voltage of the initialization signal INT.

The second initialization unit 35 initializes the node Vb of the side of the control terminal of the variable resistance transistor TFTᵥᵣ, and includes a second initialization transistor TFTᵣ₂. An input terminal of the second initialization transistor TFTᵣ₂ is connected to the node Vb, an output terminal thereof is connected to the ground, and a control terminal thereof is connected to the input terminal of the initialization signal INT. When the second initialization unit 35 initializes the node Vb, the node Vb has the ground voltage, which, in an exemplary embodiment, is zero (0) volts (V).

In an exemplary embodiment, the input terminal of the initialization signal INT of the first initialization transistor TFTᵣ₁ of the first initialization unit 30 and the second initialization transistor TFTᵣ₂ of the second initialization unit 35 receive a same signal. Thus, the first initialization unit 30 and the second initialization unit 35 are simultaneously driven. However, alternative exemplary embodiments are not limited thereto, and the timing at which the signals are applied may be different from each other.

In an exemplary embodiment, the data voltage sustainer 40 maintains a data voltage applied to a node Vc from the switching transistor TFT_{S} during a predetermined regular time, and applies the stored data voltage to the node Vb. As shown in FIG. 1, the data voltage sustainer 40 includes a third capacitor C3 connected between the node Vc and the ground, and an update transistor TFTᵤ including an input terminal connected to the node Vc, an output terminal connected to the terminal Vb and a control terminal connected to an input terminal of an update signal UPDATE. The third capacitor C3 maintains the applied data voltage during the regular time, and the update transistor TFTᵤ applies the stored data voltage to the node Vb. In an exemplary embodiment, the regular time for which the data voltage sustainer 40 maintains the applied data voltage is from a time when the switching transistor TFT_{S} is turned on to a time when the update signal UPDATE is applied.

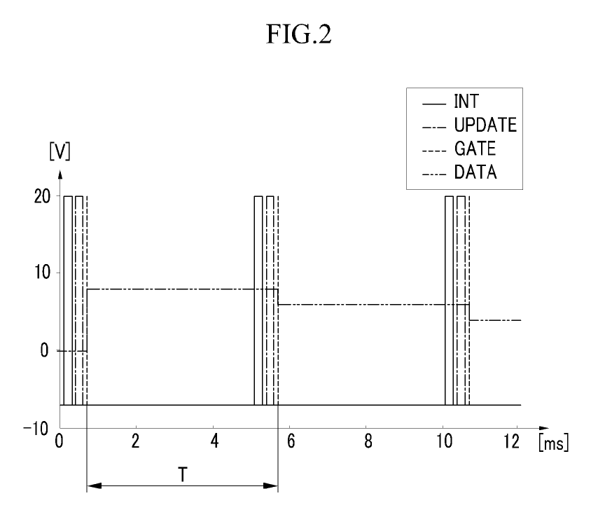

Still referring to FIG. 1, the switching transistor TFT_{S} is turned on in response to a gate signal GATE (which in an exemplary embodiment is a gate-on signal GATE) applied to the gate line GL. When the switching transistor TFT_{S} is turned on, a data voltage DATA applied to the data line DL is applied to the node Vc. In contrast, the data voltage DATA applied to the data line DL is not applied to the node Vc when the switching transistor TFT_{S} is turned off. Thus, the switching transistor TFT_{S} executes a switching operation by selectively applying the data voltage DATA to the node Vc based on the gate voltage GATE. In an exemplary embodiment, one switching operation is executed once in one frame T (FIG. 2).

A circuit operation of a process of transmitting the data voltage DATA of FIG. 1 will be described in further detail below.

In the turned on state of the switching transistor TFT_{S}, the data voltage DATA is inputted to the data voltage sustainer 40 and is applied to the node Vc.

The data voltage sustainer 40 maintains the data voltage DATA inputted to the node Vc by using the third capacitor C3 during the regular time, and when the update transistor TFTᵤ is turned on, the stored data voltage DATA is transmitted to the node Vb.

The data voltage DATA applied to the node Vb is stored by the second capacitor C2, and the voltage of the node Vb is applied to the control terminal of the variable resistance transistor TFTᵥᵣ such that the current flowing between the input and output terminals of the variable resistance transistor TFTᵥᵣ is controlled, thereby determining the resistance between the input and output terminals of the same. The voltage of the node Va charged to the first capacitor C1 is discharged while the current flows in the variable resistance transistor TFTᵥᵣ. In an exemplary embodiment, the micro-shutter electrode 10 is opened from a time when the first capacitor C1 is charged above the threshold voltage by the first initialization unit 30 to a time when the first capacitor C1 is discharged below the threshold voltage by the variable resistance transistor TFTᵥᵣ.

In an exemplary embodiment, the first initialization unit 30 and the second initialization unit 35 initialize the voltages of the control terminal and the input terminal of the variable resistance transistor TFTᵥᵣ to be correctly operated according to the input data voltage DATA. An operation of the first initialization unit 30 and the second initialization unit 35 is executed before the new data voltage DATA is applied to the node Vb, for example.

As shown in FIG. 1, predetermined initial values for simulation of an initial condition (“IC”) are shown and, more specifically, corresponding IC values of each element are listed, but alternative exemplary embodiments of the present invention are not limited to these ICs.

An operation of the pixel shown in FIG. 1 will now be described in further detail with reference to FIG. 2.

FIG. 2 is a signal timing diagram and, more particularly, is a graph of voltage, in volts (V), versus time, in milliseconds (ms), showing voltages applied to the pixel of the display device shown in FIG. 1.

As shown in FIGS. 1 and 2, the first initialization unit 30 and the second initialization unit 35 are supplied with the initialization signal INT. As a result, the first initialization unit 30 and the second initialization unit 35 initialize the input terminal and the control terminal, respectively, of the variable resistance transistor TFTᵥᵣ. As a result of the initialization, the input terminal of the variable resistance transistor TFTᵥᵣ has the voltage of the initialization signal INT, which is, for example, a voltage of 20V, and the control terminal has the ground voltage, e.g., 0V, but alternative exemplary embodiments are not limited thereto.

As shown in FIG. 2, the update signal UPDATE is supplied such that the data voltage DATA stored to the third capacitor C3 of the data voltage sustainer 40 is transmitted to the node Vb to store the data voltage DATA in the second capacitor C2. The data voltage DATA applied to the node Vb is applied to the control terminal of the variable resistance transistor TFTᵥᵣ such that the resistance of the variable resistance transistor TFTᵥᵣ is determined. A rate of voltage discharge of the node Va is controlled according to the determined resistance.

When the gate-on signal GATE is applied, the switching transistor TFT_{S} is turned on, and the data voltage DATA applied to the data line DL is applied to the node Vc to store the data voltage DATA in the third capacitor C3 of the data voltage sustainer 40. The stored data voltage DATA is maintained until the next update signal UPDATE is applied. As shown in FIG. 2, one period T, e.g., one frame T, is defined by two successive gate-on signals GATE.

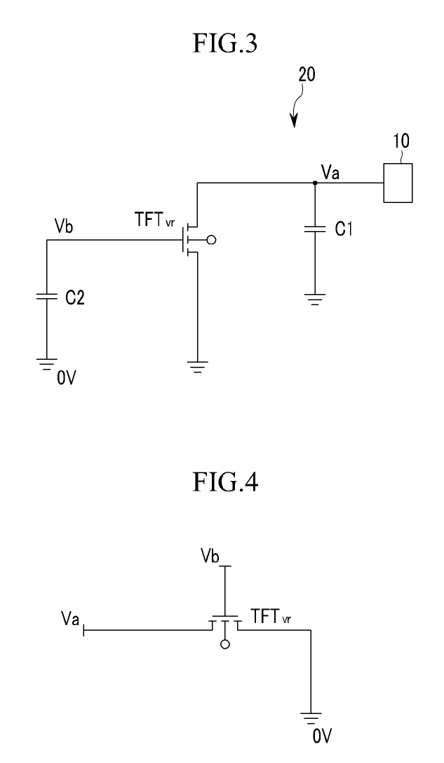

An operation of the pixel will now be described in further detail with reference to FIGS. 3 to 6.

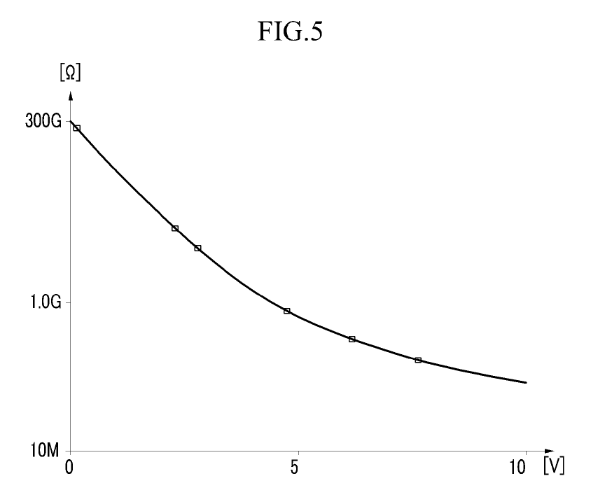

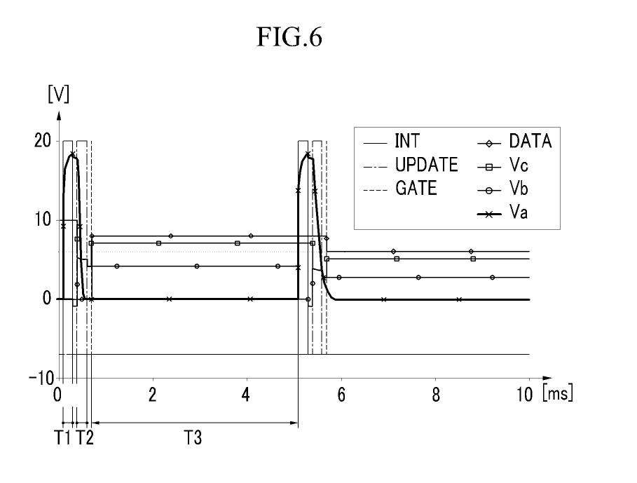

FIG. 3 is an equivalent schematic circuit diagram of the pixel of the display device shown in FIG. 1, FIG. 4 is an equivalent schematic circuit diagram of a variable resistance transistor of the pixel shown in FIG. 3, FIG. 5 is a graph of resistance, in ohms (Ω), versus voltage, in volts (V), showing a change of resistance according to an application voltage of the variable resistance transistor TFTᵥᵣ shown in FIG. 4, and FIG. 6 is a graph of voltage, in volts (V), versus time, in milliseconds (ms), showing voltages of an exemplary embodiment of the micro-shutter electrode 10 of the pixel shown in FIG. 4.

Referring now to FIG. 3, the variable resistor unit 20 having the variable resistance transistor TFTᵥᵣ will now be described in further detail. The variable resistor unit 20 shown in FIG. 3 is illustrated during a time when the first initialization transistor TFTr1 and the second initialization transistor TFTr2 of the first initialization unit 30 and the second initialization unit 35, respectively, are not operated, and when the update transistor TFTᵤ of the data voltage sustainer 40 is not operated. That is, in FIG. 3, the voltages of the nodes Va and Vb are not influenced by the abovementioned transistors. In an exemplary embodiment, the voltage of the node Vb represents the data voltage DATA stored by the second capacitor C2, and the voltage of the node Va represents the voltage initialized by the first initialization unit 30 (e.g., the voltage substantially the same as the voltage of the initialization signal INT).

Hereinafter, operation of the variable resistance transistor TFTᵥᵣ will be described in further detail with reference to FIG. 4 and FIG. 5.

FIG. 4 schematically shows connection relationships and voltage relationships of the variable resistance transistor TFTᵥᵣ of FIG. 3. Also, FIG. 5 shows a resistance of the variable resistance transistor TFTᵥᵣ that is changed according to the voltage of the node Vb. In FIG. 5, the horizontal axis represents the voltage of the node Vb, in volts (V), and the vertical axis represents the resistance, in ohms (Ω), of the variable resistance transistor TFTᵥᵣ.

As shown in FIG. 5, the resistance of the variable resistance transistor TFTᵥᵣ is changed according to the data voltage DATA stored in the node Vb, and, more specifically, the resistance of the variable resistance transistor TFTᵥᵣ decreases as the data voltage DATA increases.

The voltage of the node Vb during an interval in which the micro-shutter electrode 10 is operated in one frame T is maintained as one data voltage DATA, such that the variable resistance transistor TFTᵥᵣ has one resistance in the corresponding interval.

In this case, when the voltage is applied, as shown in FIG. 2, the voltages of the nodes Va, Vb, and Vc are changed as shown in FIG. 6.

Specifically, the control terminal of the switching transistor TFT_{S} is applied with the gate-on signal GATE, and the node Vc is supplied with the data voltage DATA. Therefore, the node Vc has a voltage corresponding to the data voltage DATA, but a voltage drop is generated while the data voltage DATA passes through the switching transistor TFT_{S} such that an actual voltage of the node Vc is lower than the data voltage DATA. When the input terminal and the output terminal of the update transistor TFTᵤ are turned on, the voltage of the node Vc (at the input terminal) and the voltage of the node Vb (at the output terminal) have substantially the same value, although a slight voltage difference between the terminals may be generated. When the gate-on signal GATE is again applied, the voltage corresponding to the data voltage DATA is charged into the node Vc, and this operation is repeated. In addition, FIG. 6 shows that the voltage of the node Vc is dropped by a predetermined amount between the update signal UPDATE and the gate-on signal GATE, generated due to parasitic capacitance generated between the thin film transistor and the pixel, and the amount of drop may be different according to the actual circuit. Also, an increase of the voltage may be generated. The voltage of the node Vc does not influence the initialization signal INT.

Referring still to FIG. 6, the voltage of the node Vb node is supplied with the data voltage DATA applied to the node Vc, through the update transistor TFTᵤ, such that when the update transistor TFTᵤ is turned on, the data voltage DATA applied to the Vc node is applied to the node Vb. However, a voltage drop is generated while passing through the update transistor TFTᵤ such that the data voltage DATA may be less than the voltage of the node Vc. As described above, the data voltage DATA may be substantially the same as the voltage of the node Vc during the time that the update signal UPDATE is applied, or the voltage drop may be generated between the update signal UPDATE and the gate-on signal GATE. When the initialization signal INT is inputted, the node Vb is connected to the ground terminal, thereby applying the ground voltage to the node Vb. Thus, the voltage of the control terminal of the variable resistance transistor TFTᵥᵣ is initialized to the ground voltage. FIG. 6 shows that the voltage of the node Vb is dropped by a predetermined amount between the update signal UPDATE and the gate-on signal GATE, due to the parasitic capacitance generated between the thin film transistor and the pixel, and the degree of drop may be different according to the circuit. Also, a voltage increase of the predetermined degree may be generated, e.g., the voltage drop may not be generated. The voltage of the node Vb does not influence the initialization signal INT.

In the structure of the pixel according to an exemplary embodiment of the present invention, the voltage applied to the micro-shutter electrode 10 is the voltage of the node Va such that the voltage change of the node Va is controls operation of the micro-shutter electrode 10, as will be described in further detail below.

As shown in FIG. 6, when the initialization signal INT is applied, the voltage of the node Va is applied with the voltage corresponding to the initialization signal INT through the first initialization transistor TFTᵣ₁ of the first initialization unit 30. Thus, the node Va has a voltage less than the voltage of the initialization signal INT, due to the voltage drop while passing through the first initialization transistor TFTᵣ₁. The initial voltage of the node Va has a predetermined voltage, and the initial voltage of the node Va has substantially the same value for all pixels and every frame.

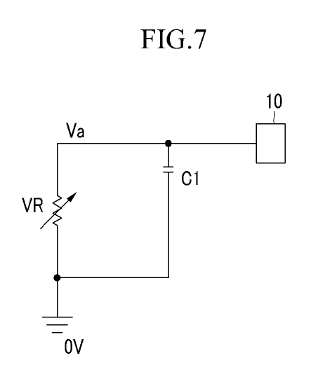

When the update signal UPDATE is applied, the resistance of the variable resistance transistor TFTᵥᵣ is determined, and the voltage is discharged at a rate determined according to a resistor-capacitor (“RC”) time constant value, as will be described in further detail below with reference to FIGS. 7 to 9.

FIG. 6 shows that the voltage of the node Va is dropped by a predetermined amount between the update signal UPDATE and the gate-on signal GATE, due to the parasitic capacitance generated between the thin film transistor and the pixel, and the degree of drop may be different according to the circuit. Also, the voltage increase of the predetermined degree may be generated, e.g., the voltage drop may not be generated. The voltage of the node Va does not influence the initialization signal INT.

Hereinafter, a change of the voltage drop speed of the node Va according to the resistance of the variable resistance transistor TFTᵥᵣ will be described in further detail with reference to FIGS. 7 to 9.

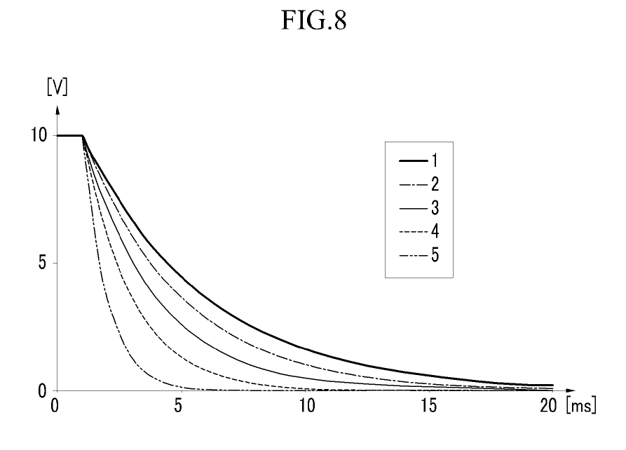

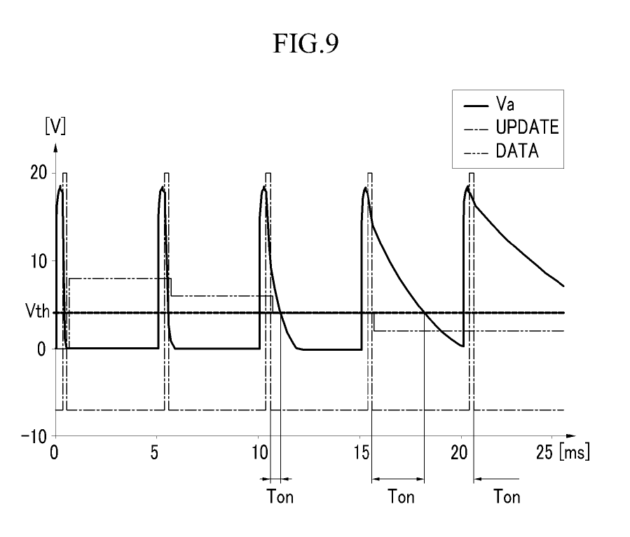

FIG. 7 is an equivalent schematic circuit diagram of the pixel of the display device shown in FIG. 1, FIG. 8 is a graph of voltage versus time showing an applied voltage and a voltage of a micro-shutter electrode of a pixel of the display device shown FIG. 1, and FIG. 9 is a graph of voltage versus time showing an on period of a micro-shutter electrode in the graph shown in FIG. 8. More particularly, FIG. 9 is a signal timing diagram showing an on period of the micro-shutter electrode 10 based on a relationship between the voltage of micro-shutter electrode 10, which changes according a resistance value of variable resistance (FIG. 7) and a threshold voltage of the micro-shutter electrode 10, as shown in FIG. 8.

In FIG. 3, the variable resistance transistor TFTᵥᵣ is operated based on the voltage of the node Vb, as described in greater detail above. In the equivalent circuit shown in FIG. 7, however, the variable resistance transistor TFTᵥᵣ of FIG. 3 is represented as a variable resistance VR, such that FIG. 7 is depicted as a general RC circuit. As discussed above, the micro-shutter electrode 10 is an electrode which shuts on and off according to the voltage of the node Va. In an exemplary embodiment, the voltage stored in the node Va is discharged according an RC time constant value, e.g., a multiple of a resistance of the variable resistance transistor TFTᵥᵣ (or, in FIG. 7, the variable resistance VR) and a capacitance of the first capacitor C1 (FIG. 3). As a result, the voltage of the node Va is decreased at a given rate, determined by the RC time constant value.

FIG. 8 is a graph showing the rate of change of the voltage of the node Va according to the RC time constant value. In FIG. 8, the horizontal axis is time, in milliseconds (ms), and the vertical axis is the voltage, in volts (V), of the node Va. Thus, FIG. 8 is a graph illustrating a change of the voltage of the node Va while decreasing the variable resistance VR from about 5 kilohm (kΩ) to about 1 kΩ in units of about 1 kΩ. More specifically, graph “1” in FIG. 8 is a case wherein the resistance is about 5 kΩ, graph “2” is a case having a resistance of about 4 kΩ, graph “3” is a case having a resistance of about 3 kΩ, graph “4” is a case having a resistance of about 2 kΩ, and graph “5” is a case having a resistance of about 1 kΩ.

Though the voltage of the node Va is initially about 10V in all cases, a discharging speed is different according to an RC time constant value and, specifically, the discharging speed of the node Va increases as the RC time constant value decreases. On the other hand, as shown in FIG. 5, the resistance of the variable resistance transistor TFTᵥᵣ decreases as the input data voltage DATA increases.

As described above, when the voltage of the node Va is changed according to the resistance of the variable resistance transistor TFTᵥᵣ (as shown in FIG. 6), the graph shown in FIG. 9 is obtained.

FIG. 9 shows the voltage of the node Va in further detail. As shown in FIG. 6, when the initialization signal INT is inputted, the voltage of the node Va increases, and when the initialization signal INT is changed to a low voltage, the voltage of the node Va starts to decrease. When the update signal UPDATE is inputted, the resistance of the variable resistance transistor TFTᵥᵣ is determined, and the voltage of the node Va is discharged at a rate based on an RC time constant determined thereby. Specifically, the discharge of the voltage of the node Va is determined by the resistance between the input and output terminals of the variable resistance transistor TFTᵥᵣ and the capacitance of the first capacitor C1. In an exemplary embodiment, the capacitance of the first capacitor C1 is fixed, such that the discharge speed of the voltage of the node Va is determined only according to the change resistance between the input and the output terminals of the variable resistance transistor TFTᵥᵣ. FIG. 9 shows the discharge speed of the voltage of the node Va that is changed according to the change of the resistance of the variable resistance transistor TFTᵥᵣ. The resistance of the variable resistance transistor TFTᵥᵣ is increased close to the right side from the curved line of the voltage of the node Va (e.g., where the input data voltage is decreased) such that it can be confirmed that the discharge speed of the voltage accordingly decreases.

As shown in FIG. 9, a threshold voltage Vth determines a point at which the micro-shutter electrode 10 is operated.

Specifically, when the voltage of the node Va is greater than the threshold voltage Vth, the micro-shutter electrode 10 is opened, thereby representing a white level, as discussed above. FIG. 9 shows corresponding periods Ton in which the white level is represented. In FIG. 9, an interval greater than the voltage of the node Va appears in two curved lines of the left of the curved lines representing the voltage of the node Va. However, a time gap of the corresponding interval is narrow, such that the time gap is an insufficient time for the micro-shutter electrode 10 to be opened, and, as a result, the micro-shutter electrode 10 is not opened.

As shown in FIG. 9, a gray value is therefore displayed as a ratio of the interval Ton during one frame T (FIG. 2). Thus, when the interval Ton is at a maximum, a brightest, e.g., highest, gray is represented, and when the interval Ton is at a minimum, the darkest, e.g., lowest, gray is represented.

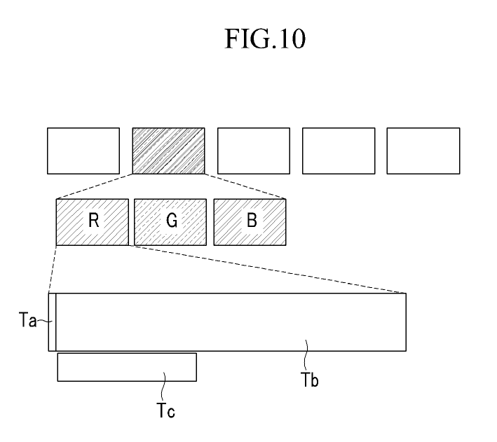

As described herein, one pixel represents the white during the interval that the micro-shutter electrode 10 is turned on in one frame, and represents the black at the remaining interval, thereby displaying the corresponding gray. Thus, since a plurality of the pixels are disposed in the display device for displaying a desired image, three primary colors of light, such as red (“R”), green (“G”) and blue (“B”), for example, are displayed for displaying the desired image in color. Hereinafter, a method for displaying a color image in the display device according to an exemplary embodiment will be described in further detail with reference to FIG. 10.

FIG. 10 is a plan view showing a subdivided frame representing an image displayed on the exemplary embodiment of the display device of FIG. 1.

Each square shown on an upper side of FIG. 10 represents a screen during one frame T. Beneath each screen, a subdivided portion thereof (only one shown in FIG. 10) during one frame is divided into screens of red R, green G and blue B colors, which are not displayed together in an exemplary embodiment, but are instead displayed sequentially, such as in a sequence of the red R, the green G and the blue B.

Under the red R, the green G and the blue B screens, the data of one of the three colors (only the red R screen is shown in FIG. 10) is enlarged, and the period that the red R screen, for example, is displayed includes a screen display preparation period Ta, a screen display period Tb and a data loading period Tc.

In an exemplary embodiment, the screen display preparation period Ta is a period to display the desired image between the screens of each color (R, G and B) and includes an application period of the initialization signal INT and the time that the voltage of the node Vc is applied to the node Vb, as described above.

The screen display period Tb is a period for displaying the luminance (e.g., the gray) while the voltage of the node Va applied to the micro-shutter electrode 10 is discharged based on the variable resistance transistor TFTᵥᵣ having the determined resistance.

The data loading period Tc is a period for applying the data voltage DATA to the data voltage sustainer 40 for an entire pixel when the gate-on signal GATE is sequentially applied to the gate lines GL, and the data voltage DATA is applied to the entire pixel. In an exemplary embodiment shown in FIG. 1, for example, the data loading period Tc overlaps the portion of the screen display period Tb due to the data voltage sustainer 40, as shown in FIG. 1. That is, the switching transistor TFT_{S} is turned on while the micro-shutter electrode 10 executes the on/off operation such that the data voltage DATA is stored in the data voltage sustainer 40, and then the screen display period Tb of the next frame is started, while, simultaneously, the update signal UPDATE is applied to the entire pixel of the display device to apply the date voltage from the entire pixel to the control terminal of the variable resistance transistor TFTᵥᵣ thereby determining a resistance of the same.

In an exemplary embodiment, the data loading period Tc is not separately executed, such that the period for display of the image is increased to substantially improve the luminance, and the update signal UPDATE is applied to the entire pixel when the data voltage DATA is stored in the data voltage sustainer 40 for the entire pixel of the display device. Accordingly, all of the pixels simultaneously execute the discharging operation, and, as a result, the process of applying the signals to the pixels is simplified.

In one or more exemplary embodiments, the data voltage sustainer 40 may be omitted, as will now be described in further detail with reference to FIG. 10.

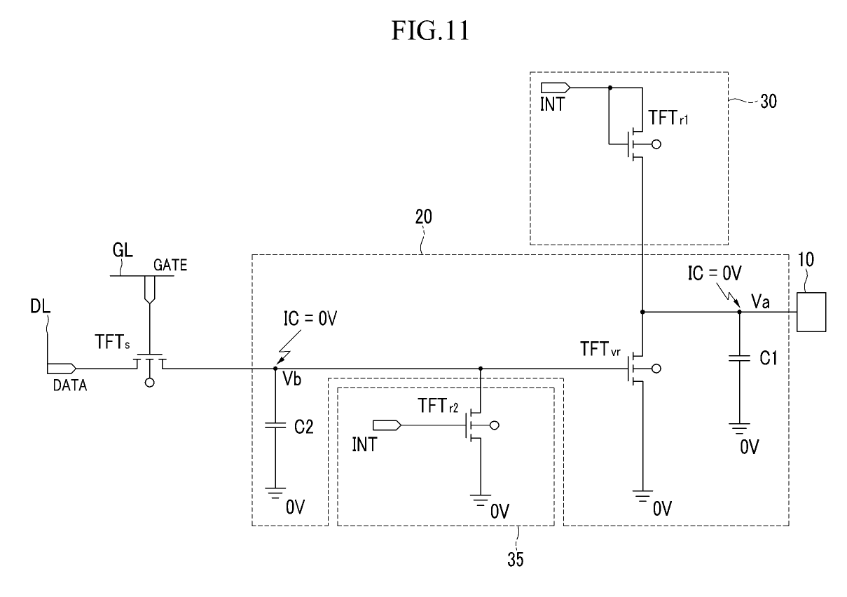

FIG. 11 is a schematic circuit diagram of an exemplary embodiment of a display device according to the present invention.

In an exemplary embodiment, a data voltage sustainer 40 is not provided, but the remaining configuration is substantially the same as for the exemplary embodiments described above in greater detail with reference to FIG. 1. Accordingly, any repetitive detailed descriptions of the same or like components has been omitted.

Referring to FIG. 11, the switching transistor TFT_{S} repeats the operation of turning on or turning off according to the gate-on signal GATE applied to the gate line GL. When the switching transistor TFT_{S} is turned on, the data voltage DATA applied to the data line DL is applied to the node Vb. In contrast, the data voltage DATA applied to the data line DL is not applied to the node Vb node when the switching transistor TFT_{S} is turned off That is, the switching transistor TFT_{S} executes the switching operation in which the data voltage DATA is applied to the node Vb node or not, based on the gate voltage GATE. In an exemplary embodiment, the switching operation is executed once for one frame T.

The data voltage DATA is applied to the node Vb in the turn on state of the switching transistor TFT_{S}, and is maintained during one frame T by the second capacitor C2.

The data voltage DATA applied to the node Vb is applied to the control terminal of the variable resistance transistor TFTᵥᵣ such that a resistance value between the input and output terminals of the variable resistance transistor TFTᵥᵣ is determined. The variable resistance transistor TFTᵥᵣ is operated as a resistor based on the determined resistance, and the micro-shutter electrode 10 is operated while discharging the voltage of the node Va based on the resistance value of the variable resistance transistor TFTᵥᵣ.

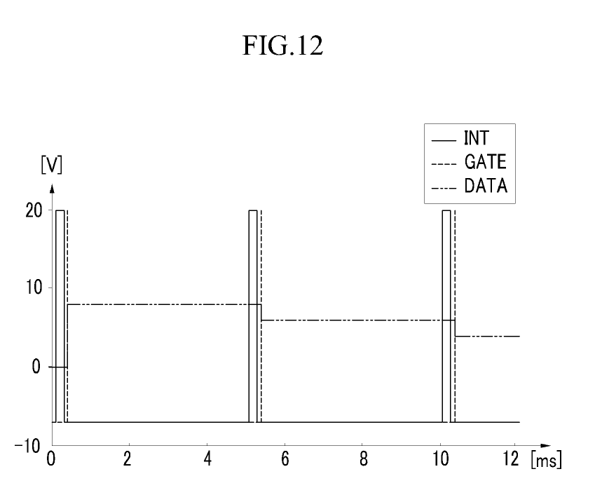

FIGS. 12-14 are graphs of voltage versus time showing voltages of the exemplary embodiment of the display device shown in FIG. 11.

An operation of the pixel of FIG. 11 will now be described with reference to FIG. 12, which is a signal timing diagram showing a driving voltage applied to the pixel of the display device of FIG. 11.

As shown in FIG. 12, the first initialization unit 30 and the second initialization unit 35 are supplied with the initialization signal INT. As a result, the first initialization unit 30 and the second initialization unit 35 initialize the input terminal and the control terminal, respectively, of the variable resistance transistor TFTᵥᵣ. Due to the initialization, the input terminal of variable resistance transistor TFTᵥᵣ has the voltage corresponding to the voltage of the initialization signal INT (e.g., 20V, as shown in FIG. 12), and the control terminal of the variable resistance transistor TFTᵥᵣ has the ground voltage, e.g., 0V.

When the gate-on signal GATE is applied to turn on the switching transistor TFT_{S}, the data voltage DATA applied to the data line DL is applied to the control terminal (node Vb) of the variable resistance transistor TFTᵥᵣ.

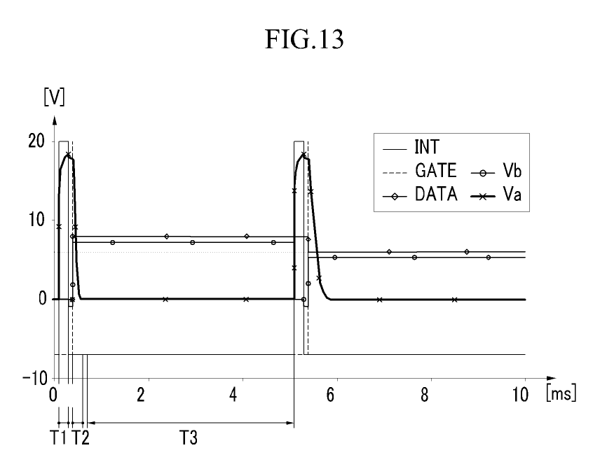

An operation of the pixel when the signal is applied (as in FIG. 12) will now be described in further detail with reference to FIG. 13.

FIG. 13 is a graph showing a voltage applied to the pixel shown in FIG. 11 and a voltage of the micro-shutter electrode 10 according to an exemplary embodiment.

When the voltage is applied as in FIG. 12, the voltages of the nodes Va and Vb are changed as shown in FIG. 13.

When the gate-on signal GATE is applied to the control terminal of the switching transistor TFT_{S}, the data voltage DATA is applied to the node Vb. In an exemplary embodiment, the node Vb has a voltage corresponding to the data voltage DATA, however a voltage drop is generated while the data voltage DATA passes through the switching transistor TFT_{S}, such that the voltage at the node Vb is less than the applied data voltage DATA.

However, the node Vb is connected to the ground terminal when the initialization signal INT is inputted to the second initialization transistor TFTᵣ₂, such that the node Vb has the ground voltage, e.g., 0V. Accordingly, the voltage of the control terminal of the variable resistance transistor TFTᵥᵣ is initialized to the ground voltage. FIG. 13 shows that the voltage of the node Vb is dropped by a predetermined amount between the initialization signal INT and the gate-on signal GATE, due to a parasitic capacitance between a thin film transistor and the pixel, and a degree of the drop may be different according to the circuit. In an exemplary embodiment, the voltage increases to some degree, e.g., the voltage drop may not be generated.

In an exemplary embodiment of the present invention, the voltage, relative to the threshold voltage of the micro-shutter electrode 10, is the voltage of the node Va, such that a rate of the voltage change of the node Va determines a resistance value of the variable resistance transistor TFTᵥᵣ, as will be described in further detail below.

As shown in FIG. 13, when the node Va is supplied with the initialization signal NT, the voltage corresponding to the initialization signal INT is applied to the node Va through the first initialization transistor TFTᵣ₁ of the first initialization unit 30. That is, a voltage drop of some degree is generated while passing through the first initialization transistor TFTᵣ₁, such that the node Va has a lower voltage than the voltage of the initialization signal INT. The initial voltage of the node Va has the predetermined voltage, and, in an exemplary embodiment, the initial voltage of the node Va has the same value for all pixels and every frame.

When the gate-on signal GATE is applied to the control terminal of the switching transistor TFT_{S}, the resistance of the variable resistance transistor TFTᵥᵣ is determined such that the voltage is discharged with the speed according to the RC time constant value.

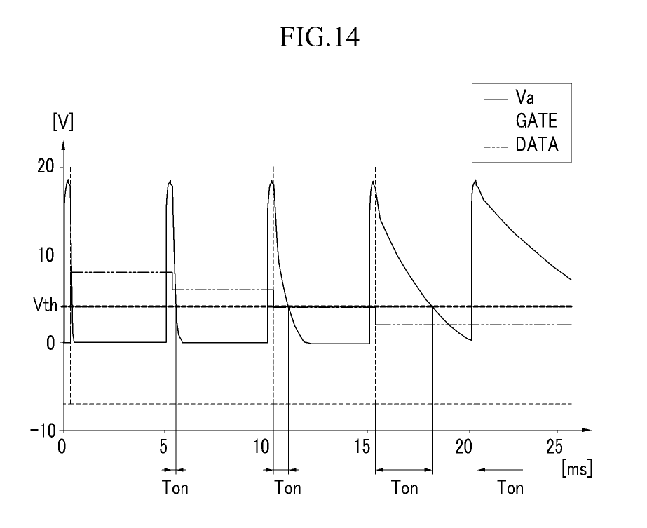

FIG. 14 a graph showing an on period of the micro-shutter electrode 10 according to a relationship between the voltage of micro-shutter electrode 10 that is changed according the variable resistor and a threshold voltage of the micro-shutter electrode 10.

When the voltage of the node Va that is changed according to the resistance of the variable resistance transistor TFTᵥᵣ is applied to FIG. 13, the graph of FIG. 14 may be gained.

As described above, when the initialization signal INT is inputted, the voltage of the node Va increases, and when the initialization signal INT changes to a low voltage, the voltage of the node Va starts to decrease. When the gate-on signal GATE is inputted, the resistance of the variable resistance transistor TFTᵥᵣ is determined, such that the voltage of the node Va is discharged at a predetermined rate. The discharge rate of the voltage of the node Va is determined by the resistance of the variable resistance transistor TFTᵥᵣ and the capacitance of the first capacitor C1. In an exemplary embodiment, the capacitance of the first capacitor C1 is fixed, such that the discharge speed of the voltage of the node Va is determined according to the given resistance of the variable resistance transistor TFTᵥᵣ in a given period. Specifically, FIG. 14 shows that the discharge speed of the voltage of the node Va is changed according to a change of the resistance of the variable resistance transistor TFTᵥᵣ. The resistance of the variable resistance transistor TFTᵥᵣ is increased (as the input data voltage DATA is decreased) as the curved line is close to the right side among the curved lines of the voltage of the node Va such that it may be confirmed that the discharge speed of the voltage is reduced.

FIG. 14 shows a threshold voltage Vth for operating the micro-shutter electrode 10.

Specifically, when the voltage of the node Va is greater than the threshold voltage Vth, the micro-shutter electrode 10 is opened, thereby displaying the white. FIG. 14 shows the interval corresponding thereto as “Ton.” As shown in FIG. 14, the gray is displayed as a ratio during which the interval Ton is on during one frame T. That is, when the interval Ton is a maximum, the brightest gray is represented, and when the interval Ton is at a minimum, the darkest gray is represented.

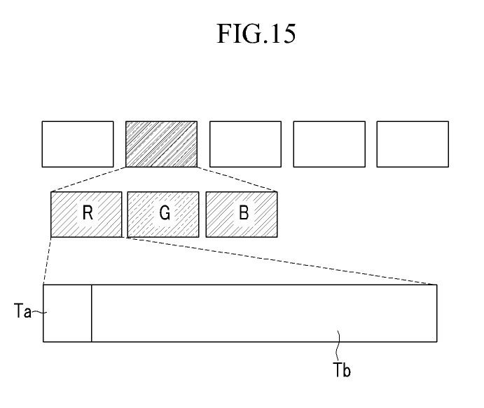

As described above, one pixel of a plurality of the pixels displays the white during the interval that the micro-shutter electrode 10 is turned on in one frame, and displays the black during the remaining interval, thereby displaying a gray level. In this way, the display device, which includes the plurality of pixels, thereby displays a desired image, and the three primary colors of light (such as the red R, the green G, and the blue B) are provided for realizing a full color display. Hereinafter, a method for displaying the color image on the display device according to an exemplary embodiment will be described in further detail with reference to FIG. 15.

FIG. 15 is a plan view showing a subdivided frame representing an image displayed on the display device of FIG. 11,

Each square shown on the upper portion of FIG. 15 is a screen that is represented during one frame. Under the screens that are applied during the one frame, each screen (only one shown in FIG. 15) is divided into the screens of the red R, the green G and the blue B. In an exemplary embodiment, these R, G and B screens are not simultaneously displayed, but are instead sequentially displayed in a sequence such as red R, green G and then blue B.

Under the red R, the green G and the blue B screens in FIG. 15, a period in which each of these screens (only the red R screen is shown in FIG. 15) is displayed includes a screen display preparation period Ta and a screen display period Tb.

The screen display preparation period Ta is a period in which the image is displayed between the screens of each color (R, G and B) included in an application period of the initialization signal INT, and the time in which the data voltage DATA is applied to the control terminal of the variable resistance transistor TFTᵥᵣ according to an exemplary embodiment of the present invention.

The screen display period Tb is a period for displaying the luminance, e.g., the gray value, while the voltage applied to the micro-shutter electrode 10 is discharged based on the variable resistance transistor TFTᵥᵣ having the determined resistance.

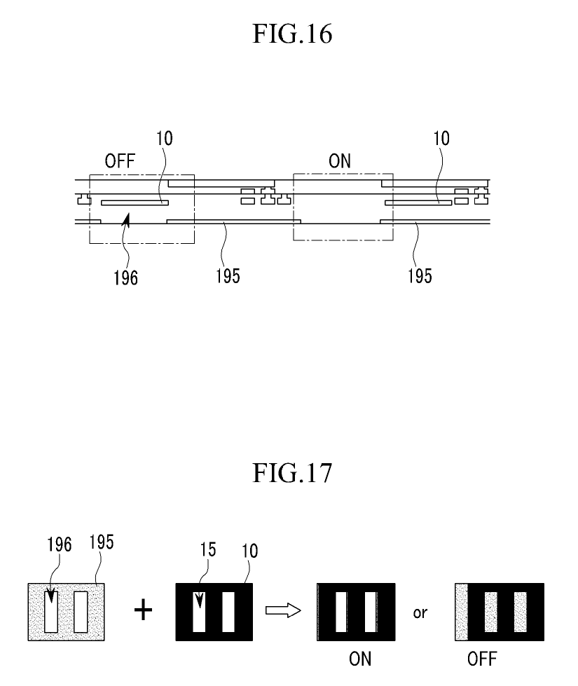

Hereinafter, one or more exemplary embodiments of the micro-shutter electrode 10 will be described in further detail with reference to FIGS. 16 to 18.

Next, a structure of the micro-shutter electrode 10 that is moved in a linear type method will be described in further detail with reference to FIGS. 16 and 17.

FIG. 16 is a partial cross-sectional view of the display device of FIG. 11, and FIG. 17 is a plan view showing an exemplary embodiment of a structure and an operation of the micro-shutter electrode 10 according to the present invention.

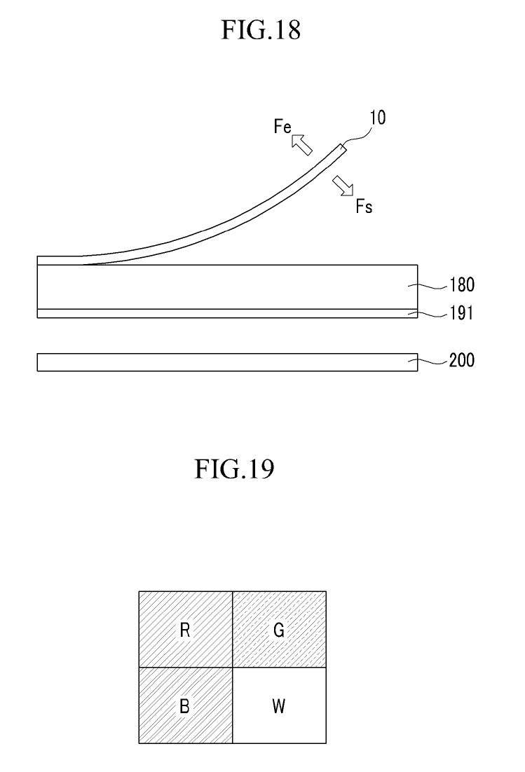

According to an exemplary embodiment of the present invention, the micro-shutter electrode 10 is horizontally moved, e.g., in right and left directions (as shown in FIG. 16) by an elastic force Fe (FIG. 18) and a static electricity force Fs (FIG. 18). Although not shown in drawings, the elastic force is applied in one direction (e.g., in the left direction, as viewed in FIG. 16) of the micro-shutter electrode 10, and the static electricity force is applied in the other direction (e.g., the right direction thereof). When the static electricity force Fs is less than the elastic force Fe, the micro-shutter electrode 10 is moved in the left direction, and the micro-shutter electrode 10 thereby blocks an opening region 196 of a blocking portion 195 (FIG. 16) such that light incident from a lower side thereof is blocked, thereby displaying the black. In contrast, when the static electricity force Fs is greater than the elastic force Fe, the micro-shutter electrode 10 is moved in the right direction, and the micro-shutter electrode 10 uncovers the opening region 196 of the blocking portion 195, such that the light is transmitted therethrough, thereby displaying the white.

FIG. 17 shows the micro-shutter electrode 10, a shape of the blocking portion 195, an on state ON and an off state OFF represented by the same.

In an exemplary embodiment, the micro-shutter electrode 10 and the blocking portion 195 include the opening regions 15 and 196, respectively. The two opening regions 15 and 196 correspond to each other in the on state, thereby displaying the white such that the light is transmitted, and the two opening regions 15 and 196 deviate from each other, e.g., do not correspond to each other, in the off state, thereby displaying the black such that the light is blocked.

The opening regions 15 and 196 of the micro-shutter electrode 10 and the blocking portion 195 shown in FIG. 17 may correspond to one pixel area, however the micro-shutter electrode 10 and blocking portion 195 according to an exemplary embodiment may include a plurality of opening regions 15 and 196 which may correspond to one pixel area. When one pixel area corresponds to the plurality of opening regions 15 and 196, a range over which the micro-shutter electrode 10 is moved in the right and left directions is decreased, such that there the light may be blocked and transmitted based on a reduced motion of the micro-shutter electrode 10 (as compared to in an exemplary embodiment in which only one each of the opening regions 15 and 196 are provided).

FIG. 18 is a partial cross-sectional view of an exemplary embodiment of a micro-shutter electrode according to the present invention.

As shown in FIG. 18, one end of the micro-shutter electrode 10 is fixed and another end thereof is moveable. Specifically, the micro-shutter electrode 10 receives the elastic force Fe and the static electricity force Fs. In an exemplary embodiment, the static electricity force Fs is an attraction force with which an additional electrode 191 and the micro-shutter electrode 10 are attracted to each other. In FIG. 18, an insulating layer 180 is disposed between two electrodes, e.g., the micro-shutter electrode 10 and the additional electrode 191, and a backlight unit 200 is disposed beneath the abovementioned components.

When the elastic force Fe applied to the micro-shutter electrode 10 is greater than the static electricity force Fs, the micro-shutter electrode 10 is opened, such that the light emitted from the backlight unit 200 is transmitted upward (as viewed in FIG. 18), thereby displaying the white. In contrast, when the elastic force Fs applied to the micro-shutter electrode 10 is greater than the elastic force Fe, the micro-shutter electrode 10 is disposed on the insulating layer 180, such that the light emitted from the backlight unit 200 is not transmitted, but is instead effectively blocked, thereby displaying the black.

In an exemplary embodiment, the backlight unit 200 includes a light source, and the backlight unit 200 may emit a white color or, alternatively, may sequentially emit light of red R, green G and blue B colors.

In an exemplary embodiment shown in FIG. 18, the micro-shutter electrode 10 has one end fixed, but alternative exemplary embodiments are not limited thereto. For example, a central portion of the micro-shutter electrode 10 may be fixed and two opposite ends thereof may thereby move, based on the elastic force Fe and the elastic force Fs, as described above.

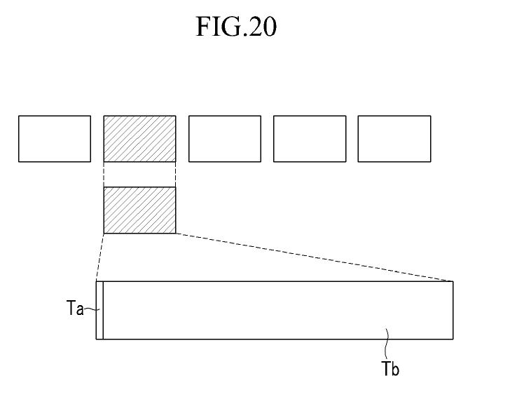

Hereinafter, an exemplary embodiment in which a pixel displays a given color by including a color filter for each pixel in the display device using the micro-shutter electrode will now be described in further detail with reference to FIGS. 19 and 20.

FIG. 19 is a plan view of a pixel in an exemplary embodiment of a display device according to the present invention, and FIG. 20 is a plan view showing a subdivided frame representing an image displayed on the display device of FIG. 19.

FIG. 19 shows a case in which subpixels of four colors form one pixel. In an exemplary embodiment, each subpixel includes substantially the same structure as shown in the exemplary embodiments of FIG. 1 and/or FIG. 11.

As shown in FIGS. 10 and 15, when a color filter is not included, the backlight sequentially provides light of red R, green G and blue B to display the full color. As a result, one frame is divided into a period displaying red R, a period displaying green G and a period displaying blue B, as discussed above.

However, in an exemplary embodiment in which the color filter is included, as in the exemplary embodiment of FIG. 19, when the white light is provided from the backlight, a color is determined based on the color filter, such that red R, green G and blue B colors may be displayed at one time, e.g., in a same frame or period thereof.

Each square shown on an upper side of FIG. 20 is a screen that is represented during one frame. Each of these screens (only one shown in FIG. 20) include a preparation period Ta and a screen display period Tb. Although not shown in FIG. 20, it will be noted that a data loading period Tc may be included along with the screen display period Tb, as shown in FIG. 10. Alternatively, such as in the exemplary embodiment in which the color filter is added to the pixel of the exemplary embodiment, the data loading period Tc is not separately executed, and is instead included in the screen display preparation period Ta, such that the screen display preparation period Ta is elongated, as shown in FIG. 20.

Thus, when the color filter is used, it is not necessary to divide one frame into periods of each color (R, G and B), and a driving method of the pixel is thereby simplified.

FIG. 19 shows the structure in which subpixels of the square shaped pixel are arranged, however the shape and the arrangement of the subpixels may be variously changed in additional exemplary embodiments. Also, in an exemplary embodiment, subpixels including only three colors are used.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A display device comprising:
a gate line;
a data line;
a switching transistor connected to the gate line and the data line and controlled by a gate-on voltage supplied by the gate line;
a variable resistance unit, a resistance of which is changed based on a data voltage supplied to the variable resistance unit from the data line via the switching transistor;
a first capacitor connected to the variable resistance unit; and
a micro-shutter electrode connected to the resistance unit and the first capacitor,
wherein the micro-shutter electrode executes a shutoff operation based on a voltage at a connection node between the variable resistance unit and the first capacitor.

2. The display device of claim 1, wherein the voltage at the connection node is discharged at a rate determined by a multiple of the resistance of the variable resistance unit and a capacitance of the first capacitor.

3. The display device of claim 1, wherein
the variable resistance unit includes a variable resistance transistor, and
the resistance of the variable resistance unit is a resistance between an input terminal and an output terminal of the variable resistance transistor,
and the resistance between the input terminal and the output terminal is changed based on the data voltage inputted to a control terminal of the variable resistance transistor.

4. The display device of claim 3, wherein
a first terminal of the first capacitor is connected to the micro-shutter electrode,
a second terminal of the first capacitor is connected to ground,
the input terminal of the variable resistance transistor is connected to the first terminal of the first capacitor, and
the output terminal of the variable resistance transistor is connected to ground.

5. The display device of claim 3, further comprising
a first initialization unit which initializes the voltage at the connection node.

6. The display device of claim 5, wherein the first initialization unit includes a first initialization transistor which is connected as a diode and which initializes the connection node with a first initialization signal.

7. The display device of claim 5, further comprising a second initialization unit which initializes the control terminal of the variable resistance transistor.

8. The display device of claim 7, wherein
the second initialization unit includes a second initialization transistor,
a second initialization signal is inputted to the control terminal of the variable resistance transistor,
an input terminal of the second initialization transistor is connected to the control terminal of the variable resistance transistor, and
an output terminal second initialization transistor is connected to ground.

9. The display device of claim 3, further comprising a second capacitor including a first terminal connected to the control terminal of the variable resistance transistor and a second terminal connected to ground.

10. The display device of claim 3, further comprising a data voltage sustainer disposed between the control terminal of the variable resistance transistor and an output terminal of the switching transistor.

11. The display device of claim 10, wherein the data voltage sustainer comprises:
a third capacitor which stores the data voltage transmitted via the switching transistor; and
an update transistor which transmits the data voltage stored in the third capacitor to the control terminal of the variable resistance transistor in response to an update signal.

12. The display device of claim 1, further comprising a backlight including a light source which emits light.

13. The display device of claim 12, wherein
the light includes lights having at least three colors, and
the backlight sequentially emits the lights having the at least three colors.

14. The display device of claim 12, wherein the backlight emits white light.

15. The display device of claim 14, further comprising a color filter which colors the white light emitted from the backlight.

16. The display device of claim 15, wherein the color filter includes at least three colors.

17. The display device of claim 1, wherein the micro-shutter electrode includes an opening.

18. A driving method of a display device for driving a pixel including a gate line, a data line, a switching transistor connected to the gate line and the data line, a micro-shutter electrode, a first capacitor connected to the micro-shutter electrode, a variable resistance transistor connected to the micro-shutter electrode and the first capacitor, and a data voltage sustainer disposed between the switching transistor and the control terminal of the variable resistance transistor, the method comprising:
initializing the variable resistance transistor;
transmitting a data voltage stored in the data voltage sustainer to a control terminal of the variable resistance transistor;
applying a gate-on voltage to the gate line to transmit the data voltage applied to the data line to the data voltage sustainer; and
executing a shutoff operation of the micro-shutter electrode based on a rate of voltage discharge determined by a resistance of the variable resistance transistor and a capacitance of the first capacitor.

19. The driving method of claim 18, wherein the transmitting the data voltage to the data voltage sustainer and the executing the shutoff operation of the micro-shutter electrode are performed simultaneously.

20. The driving method of claim 18, wherein
the display device further includes a plurality of pixels, and
the transmitting the data voltage stored in the data voltage sustainer to the control terminal of the variable resistance transistor is simultaneously performed for all pixels of the plurality of pixels of the display device.
